(19) United States
(12) Patent Application Publication
(10) Pub. No.: US 2009/0014477 A1
(43) Pub. Date: Jan. 15, 2009

(54) Pressure module for dispensing chemical solutions

(76) Inventor: Ronald Brenes, Houston, TX (US)

Correspondence Address: Raymond R. Ferrera, 1221 McKinney Street, Suite 4400, Houston, TX, 77010, US

(21) Appl. No.: 12/217,876

(22) Filed: Jul. 9, 2008

Related U.S. Application Data
(63) Continuation-in-part of application No. 12/082,713, filed on Apr. 14, 2008.
(60) Provisional application No. 60/923,088, filed on Apr. 12, 2007.

(51) Int. Cl. B67D 5/54

(52) U.S. Cl. 222/399

(57) ABSTRACT

A module for dispensing chemical solutions includes an incoming chemical feed line disposed in permissive mechanical communication with a dispensing module and an external reservoir, wherein the incoming chemical feed line is configured to supply the module with a chemical solution. The module further includes an outgoing chemical flow line disposed in mechanical communication therewith, such that the outgoing chemical feed line is configured to dispense the chemical solution. Additionally, a pressurized cylinder is disposed in fluid communication with both the incoming chemical feed line and the outgoing chemical feed line. The module further includes a pressure gauge disposed in fluid communication with the pressurized cylinder and a transport device having one or more of a standing element and a moving element, wherein the transport device is configured to support the weight of the pressurized cylinder and allow portable movement of the module.

### RELATED APPLICATION DATA

The instant application is a continuation-in-part of U.S. Non-Provisional application Ser. No. 12/082,713 filed Apr. 14, 2008, still pending, which claims the benefit of prior Provisional Application No. 60/923,088, filed Apr. 12, 2007.

### FIELD OF THE INVENTION

The present invention relates generally to pressurized modules for dispensing industrial chemical solutions, and in a particular though non-limiting embodiment, to a CO₂ gas generator type beverage dispenser adapted for application of industrial chemical solutions such as window tinting solutions, window cleaners, pesticides, weed killers, tire dressings, car washing solutions, carpet shampoos and protective dressings, disinfectants, spot removers, degreasers and graphic solutions.

Those of ordinary skill in the art will appreciate that the adapted dispenser described herein would be suitable for use in connection with many other chemical solutions as well, but would generally not be suitable for use in connection with commonly known acids, corrosives and/or oxidizers.

### BACKGROUND

Known beverage dispensers, which dispense syrups and carbonated water to produce a carbonated beverage, typically use a pressurized cylinder containing CO₂ as part of the apparatus. Such systems generally require complex external pressure controls to ensure the correct degree of carbonation, and to provide a constant associated water pressure while dispensing. The latter is essential for providing proper control of the water-syrup dispensing ratio in a constant carbonation level while water is being drawn from either an on-board or external supply. Conventional CO₂ beverage cylinders comprise high-pressure containers that are necessarily returnable, refillable packages that typically require external control of associated fluid pressures and related safety devices for safe operation.

To date, however, the advantages of adapting such a cylinder for the purpose of dispensing any of the industrial chemicals mentioned above in a safe and reliable, significantly more efficient, and carefully controlled manner have not been appreciated.

### SUMMARY

Embodiments include an incoming chemical feed line disposed in permissive mechanical communication with an external reservoir and a dispensing module, wherein the incoming chemical feed line is configured to supply the module with a chemical solution. Embodiments further include an outgoing chemical flow line disposed in mechanical communication with the module, wherein the outgoing chemical feed line is configured to dispense the chemical solution. In one embodiment, a pressurized cylinder is disposed in fluid communication with said incoming chemical feed line and said outgoing chemical feed line.

Example embodiments further include a pressure gauge disposed in fluid communication with a pressurized cylinder, and a transport device having one or more of a standing element and a moving element, wherein the transport device is configured to support the weight of the pressurized cylinder and allow portable movement of the module.

### BRIEF DESCRIPTION OF THE DRAWINGS

The embodiments disclosed herein will be better understood, and numerous objects, features, and advantages made apparent to those skilled in the art by referencing the accompanying drawings.

FIG. 1 is a schematic diagram of components included a module for dispensing chemical solutions, according to example embodiments.

FIG. 2 is a front view of a module for dispensing chemical solutions, according to example embodiments.

### DESCRIPTION OF EMBODIMENT(S)

The description that follows includes exemplary systems, methods, and techniques that embody techniques of the presently inventive subject matter. However, it is understood that the described embodiments may be practiced without these specific details. In other instances, well-known manufacturing equipment, protocols, structures and techniques have not been shown in detail in order to avoid obfuscation in the description.

Embodiments of the inventive subject matter utilize a provision of a pressure cylinder that can be filled and used by an operator in a safe and controlled manner, such that internal canister pressures are carefully regulated, and wherein the adapted apparatus can be easily moved and used by operators with a minimum of effort and operational down time. Further embodiments function in such a fashion as to allow an operator to recharge the device and continue with operations should sufficient amounts of fluid be dispensed during operations as to otherwise require offsite recharging.

Moreover, those of ordinary skill in the art will appreciate that the adapted dispenser described herein would be suitable for use in connection with many other chemical solutions as well, but would generally not be suitable for use in connection with commonly known acids, corrosives and/or oxidizers.

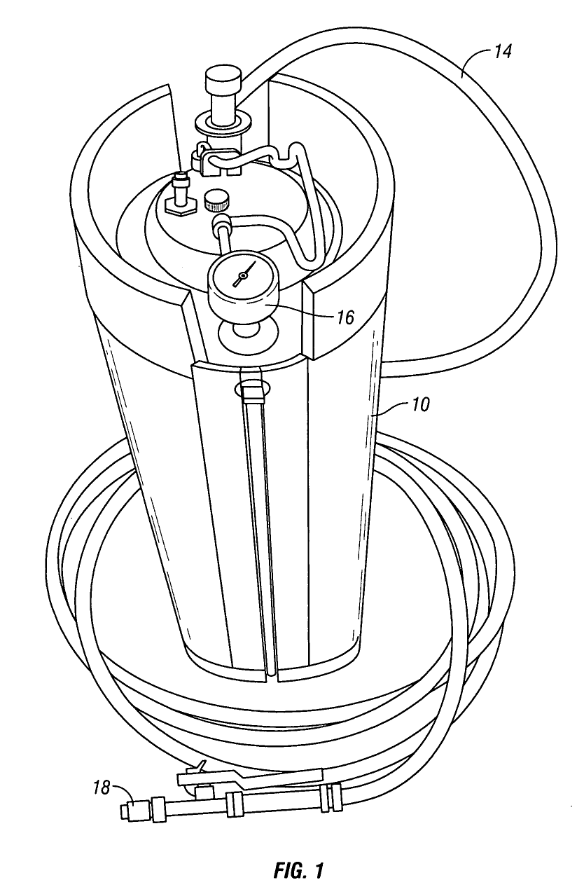

According to the example embodiment depicted in FIG. 1, a known beverage cylinder 10 suitable for storing and dispensing a non-corrosive chemical solution is adapted to include an incoming chemical feed line 12 (not shown), an outgoing chemical flow line 14, and a pressure gauge 16 disposed in fluid connection therewith.

The incoming chemical feed line 12 can comprise any known material, for example, a plastic or metal material, but should in any event be capable of containing at least the pressure of any gaseous feed passed therethrough. The feed line can comprise a nipple or valve type adapter for receiving process flow from an external line, or can instead comprise a fixed valve and line combination through which solution can be loaded. In any event, the purpose of the feed line is to securely connect to both an external reservoir of the chemical solution at one end, and to the adapted beverage cylinder at the other, in order to safely and reliably charge the cylinder 10 with a chemical solution prior to dispensing.

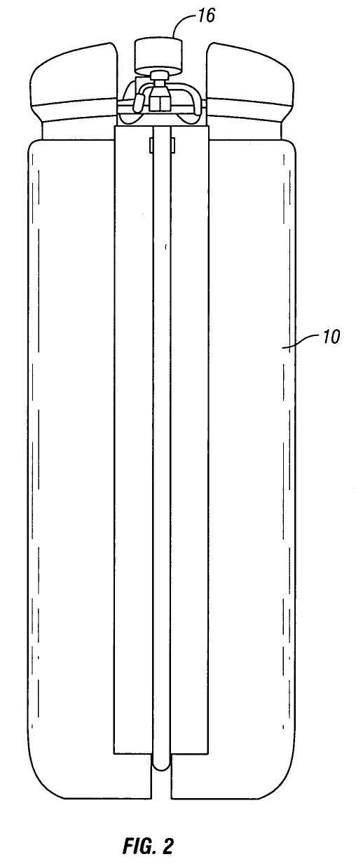

The pressure gauge 16 disposed in fluid connection therewith measures and displays the internal pressure contained within the charged cylinder 10 to ensure that predetermined operational safety limits are not exceeded, and to ensure that appropriate internal pressure limits are maintained so that an effective operational range for dispensing the solution is achieved (See FIG. 2).

In alternative embodiments, the pressure gauge 16 also contains a fluid volume gauge, so that the absolute volume levels of solution contained within the cylinder 10 are determined, though in other embodiments, the volume gauge comprises a separate component disposed in fluid communication with the cylinder 10, and in further embodiments still, the volume gauge is absent from the system. Those of ordinary skill in the art will appreciate that since the maximum volume of the cylinder 10 is always known due to the fixed geometry of the device, the volume of solution present in the module can also be inferred by comparing the pressure indicated by the pressure gauge 16 and the volume of solution and air or other gasses added during charging.

The purpose of the outgoing chemical flow line 14 is to provide a means by which the solution may ultimately be dispensed. As would be readily understood by those of skill in the art, the flow line would typically be capped at its terminus end by a spray gun 18 or nozzle or the like, so that a chemical solution can be dispensed in a concentrated and controlled fashion by an operator.

As with the incoming chemical feed line 12 described above, the outgoing chemical flow line 14 can comprise any known material, for example, a plastic or metal material, but should in any event be capable of containing at least the pressure of any gaseous feed passed therethrough. The outgoing chemical flow line 14 can also comprise either a nipple or valve type adapter for receiving process flow from inside the cylinder 10 prior to dispensing, or can instead comprise a fixed valve and line combination through which solution can be dispensed. In any event, the purpose of the outgoing chemical flow line 14 is to securely connect to both an internal reservoir of the cylinder 10 and the spray gun 18 or nozzle like dispenser in order to safely and reliably dispense the solution during operations.

As will be understood by those of skill in the art, pressure and volume control, and the fluid flow characteristics of both the incoming chemical feed line 12 and the outgoing chemical flow line 14 can be improved by means of jets, constricting fasteners which concentrate the solution prior to charging or dispensing, etc.

According to further aspects of the invention, a cart-like device is provided for transporting and maneuvering the cylinder 10 during travel between jobs and/or during application of chemicals during operations. According to one example embodiment, a cart comprising a material sufficiently strong to bear the weight of a charged cylinder 10 (e.g., a cart formed from metal tubing or the like), is equipped with a plurality of wheels and/or a standing member such that an operator controlling the device by means of a handle disposed above the loaded cylinder 10 can safely and reliably wheel the device into place prior to operations, and then safely stand the cart fixedly in place while operations are carried out.

If the cylinder 10 is equipped with a sufficient length of outgoing chemical flow line 14 capped by a nozzle or dispensing gun or the like, the cart and cylinder 10 combination can be left in place while the operator maneuvers the flow line into place for dispensing operations. If the operator requires or desires additional slack or maneuverability for a particular application, the cart can simply be wheeled into a second location, again fixed in place, and dispensing operations continued.

While the embodiments are described with reference to various implementations and exploitations, it will be understood that these embodiments are illustrative and that the scope of the invention is not limited thereby. In general, embodiments of a pressure module for dispensing chemical solutions as described herein may be implemented using methods, facilities, and devices consistent with any appropriate structural or mechanical systems. Many variations, modifications, additions, and improvements are also possible without departing from the spirit or scope of the invention as claimed.

For example, plural instances may be provided for components, operations or structures described herein as a single instance. Boundaries between various components, operations and functionality are depicted somewhat arbitrarily, and particular operations are illustrated within the context of specific illustrative configurations. Other allocations of functionality are envisioned and will also fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may also fall within the scope of the inventive subject matter.

What is claimed is:

1. A module for dispensing chemical solutions, said module comprising:
an incoming chemical feed line disposed in permissive mechanical communication with an external reservoir and said module, wherein said incoming chemical feed line is configured to supply said module with a chemical solution;
an outgoing chemical flow line disposed in mechanical communication with said module, wherein said outgoing chemical feed line is configured to dispense said chemical solution;
a pressurized cylinder disposed in fluid communication with said incoming chemical feed line and said outgoing chemical feed line; and
a pressure gauge disposed in fluid communication with said pressurized cylinder, wherein said pressure gauge is configured to monitor one or more operational limits of said module.

2. The module for dispensing chemical solutions of claim 1, wherein said module further comprises:
a transport device comprising one or more of a standing element and a moving element, wherein said transport device is configured to allow portable movement of said module.

3. The module for dispensing chemical solutions of claim 2, wherein said transport device is further configured to support the weight of said module.

4. The module for dispensing chemical solutions of claim 1, wherein said incoming chemical feed line further comprises:
an adapter configured to attach said incoming chemical feed line to an external chemical solution supply source.

5. The module for dispensing chemical solutions of claim 1, wherein said outgoing chemical flow line further comprises:
an adapter configured to attach said outgoing chemical flow line to an external chemical solution supply source.

6. The module for dispensing chemical solutions of claim 1, wherein said outgoing chemical flow line is further disposed in permissive mechanical communication with a dispensing device, wherein said dispensing device is configured to release said chemical solution from said pressurized cylinder.

7. The module for dispensing chemical solutions of claim 1, wherein said pressure gauge is further configured to determine a volume level of said chemical solution contained in said pressurized cylinder.

8. A system for dispensing chemical solutions comprising:
a pressurized cylinder;
an external reservoir;
an incoming chemical feed line disposed in permissive mechanical communication with said pressurized cylinder and said external reservoir;
an outgoing chemical flow line disposed in mechanical communication with said pressurized cylinder and a dispensing device; and
a pressure gauge disposed in fluid communication with said pressurized cylinder.

9. The system for dispensing chemical solutions of claim 8 further comprising:
a transport device designed to mobilize said pressurized cylinder, wherein said transport device includes one or more of a standing element and a moving element.

10. The system for dispensing chemical solutions of claim 8, wherein said incoming chemical feed line is affixed to said pressurized cylinder at one end and to said external reservoir at the opposite end.

11. The system for dispensing chemical solutions of claim 10, wherein said external reservoir charges said pressurized cylinder with said chemical solutions via said incoming chemical feed line.

12. The system for dispensing chemical solutions of claim 8, wherein said outgoing chemical flow line is affixed to said pressurized cylinder at one end and to said dispensing device at the opposite end.

13. The system for dispensing chemical solutions of claim 12, wherein said dispensing device releases a desired amount of said chemical solution charged in said pressurized cylinder.

14. The system for dispensing chemical solutions of claim 8, wherein said pressure gauge determines a volume level of said chemical solution remaining in said pressurized cylinder.

15. The system for dispensing chemical solutions of claim 8, wherein said pressure gauge monitors one or more operational limits of said pressurized cylinder.

16. A module for dispensing chemical solutions, said module comprising:
an incoming chemical feed line disposed in permissive mechanical communication with an external reservoir and said module, wherein said incoming chemical feed line is configured to supply said module with a chemical solution;
an outgoing chemical flow line disposed in mechanical communication with said module, wherein said outgoing chemical feed line is configured to dispense said chemical solution;
a pressurized cylinder disposed in fluid communication with said incoming chemical feed line and said outgoing chemical feed line;
a pressure gauge disposed in fluid communication with said pressurized cylinder, wherein said pressure gauge is configured to monitor one or more operational limits of said module; and
a transport device comprising one or more of a standing element and a moving element, wherein said transport device is configured to allow portable movement of said module.

17. The module for dispensing chemical solutions of claim 16, wherein said module further comprises a fluid volume gauge disposed in fluid communication with said pressurized cylinder, wherein said fluid volume gauge is configured to determine a volume level of said chemical solution contained in said pressurized cylinder.
